(19) United States
(12) Patent Application Publication
(10) Pub. No.: US 2010/0043592 A1
(43) Pub. Date: Feb. 25, 2010

(54) PEDAL ASSEMBLY HAVING A SAFETY DEVICE

(75) Inventor: Mattias Johansson, Nittorp (SE)

Correspondence Address: Phan Law Group PLLC, P.O. Box 748, Alexandria, VA, 22313-0748, US

(73) Assignee: DriveSol Worldwide AB, Dalstorp (SE)

(21) Appl. No.: 12/565,788

(22) Filed: Sep. 24, 2009

Related U.S. Application Data
(63) Continuation-in-part of application No. 10/587,154, filed on May 1, 2007, now abandoned.

(30) Foreign Application Priority Data
Jan. 26, 2004 (SE) 0400135-0

(51) Int. Cl. G05G 1/46

(52) U.S. Cl. 74/560

(57) ABSTRACT

A pedal support for a vehicle includes a bracket which is secured in a bulkhead disposed in the vehicle between the passenger compartment of the vehicle and the engine room; a first shaft secured in the bracket and horizontal and transversely directed in relation to the direction of travel of the vehicle; a pedal arm provided with a footplate and pivotal about the first shaft; an operating device which is secured in the arm a distance from the first shaft and which is disposed for manoeuvring or controlling a vehicle function, for example a braking function. The first shaft is movably disposed in the bracket in the direction of travel of the vehicle, the first shaft having a normal position locked by means of a locking device, and the locking device being, in the event of a collision, openable for permitting displacement of the first shaft to a safety position where the footplate is displaced away from the legs/feet of the vehicle driver but where the function of the operating device is at least partly retained.

The present application is a continuation-in-part of U.S. application Ser. No. 10/587,154, having a §371 (c)(1), (2), (4) date of May 1, 2007, which was the U.S. national stage of PCT/SE05/00076, filed Jan. 25, 2005, and which claimed priority to Swedish application 0400135-0, filed Jan. 26, 2004, all of which are hereby expressly incorporated by reference.

### BACKGROUND AND SUMMARY

The present invention relates to a pedal support for a vehicle, comprising a bracket which is secured in a bulkhead disposed in the vehicle between the passenger compartment of the vehicle and its engine room; a first shaft which is secured in the bracket and is horizontal and transversely directed in relation to the direction of travel of the vehicle, a pedal arm provided with a footplate and pivotal about the first shaft; an operating device which is secured in the pedal arm a distance from the first shaft and which is disposed for activation or control of a vehicular function, for example a braking function.

In modern motor cars, collision safety has become an increasingly important feature. Motor car safety may be improved in that an airbag catches both the driver and passengers before they hit solid parts in the passenger compartment of the motor car. The passenger compartment lies on the inside of a so-called bulkhead. The bulkhead is a substantially vertical definition between the passenger compartment and the front area of the vehicle. On the passenger compartment side of the bulkhead, different parts may be secured, for example a pedal support in which the pedals that are used by the driver when driving the vehicle are supported. In order to increase safety even further, attempts are made, on the one hand, to prevent parts in the engine room of the vehicle from bursting through the bulkhead into the passenger compartment and, on the other hand, to cause the pedals suspended in pedal supports to be prevented from moving towards the feet of the driver. This causes a lower degree of so-called pedal penetration. Pedal penetration is a dimension of foot safety and indicates the extent to which the pedals may possibly move towards the driver in connection with a collision. Since a large degree of pedal penetration may result in serious injury to the driver, attempts are made to render pedal penetration as slight as possible.

Systems have been developed where sensors sense a collision in the front area of the vehicle and wholly disengage the function of the pedals, so-called decoupling, with the result that pedal penetration may be reduced.

This system involving decoupling is based on the triggering of a lock that disengages the pedal function. One drawback inherent in this solution is that the driver totally loses the ability to manoeuvre the vehicle with the aid of the pedals when the lock has been activated. For example, there is no possibility of braking the vehicle. This may constitute a danger to safety that could even aggravate the consequences of a road accident. What has hitherto been lacking is a safety device that gives a low level of pedal penetration in connection with a collision, but that retains at least a residual effect by the pedals once a lock has been activated in connection with a collision, with the result that the driver may continue to manoeuvre the vehicle with the aid of the pedals and minimise further damage and injury in that the vehicle can, for example, be braked.

Pedal supports are also previously known in the art that are designed to reduce pedal penetration in that the pedals, as a result of deformation in the vehicle chassis, are caused to move away from the feet of the vehicle driver. For example, such pedal supports can utilise a deformation in the bulkhead, a wheel housing or other vehicle body part in relation to a “fixed” point in the chassis, for example in or beneath the dashboard of the vehicle, in order to realise the movement that displaces the pedals.

It is desirable to obviate or at least minimise the above-outlined problems.

It is desirable to realise a safety device for which there is provided a lock which is actively triggered in connection with a collision, but where there is subsequently an extreme point at which the pedal shaft is arrested so that an upper pivotal point for the pedal arm is obtained around which the pedal arm may move and continue to impart to the pedal the ability to act, possibly with a reduced effect.

The advantages inherent in an aspect of the present invention are that a pedal support with low pedal penetration will be realised at the same time as the total safety of a motor car provided with the present safety device is increased in that the pedals retain at least a certain effect even after a collision.

### BRIEF DESCRIPTION OF THE ACCOMPANYING DRAWINGS

The present invention will now be described in greater detail hereinbelow, with reference to the accompanying Drawings. In the accompanying Drawings:

FIG. 1 is a perspective view of a pedal support according to a first embodiment of the present invention, where the pedal support is in the deactivated position;

FIG. 2 shows the pedal support of FIG. 1 when the safety device is in the process of being activated in that an upper lock is lifted upwards;

FIG. 3 shows the pedal support of FIG. 1, where the lock has been completely lifted upwards and has ceased to act and the pedal has a residual function, but with the pedal in a position located ahead of the normal position,

FIG. 4 shows an alternative embodiment of the present invention in perspective, the safety device not being activated but the pedal instead having full effect; and

FIG. 5 shows the embodiment according to FIG. 4 where the safety device has been triggered after a collision and the pedal has retained a residual function, but in a position ahead of the normal position.

### DETAILED DESCRIPTION

The present invention relates to a device for a pedal support in a vehicle. A pedal support is placed at the driver's position in the vehicle and may, for example, support the clutch pedal, accelerator pedal or brake pedal. In rough outline, a vehicle may be divided into a front area, passenger compartment and rear area. The front area of the vehicle includes the engine room. The passenger compartment includes the driver's seat and the passenger seats in the front and back. The rear area of the vehicle includes the luggage boot and adjacent spaces. In the front region of the passenger compartment, there is provided a substantially vertical definition which defines the passenger compartment from the front area of the vehicle. This definition is often called a bulkhead. On the bulkhead, various parts in the passenger compartment may be secured. The function of the bulkhead is to act both a securement surface and as a safety barrier for the passengers in the passenger compartment in the event of a collision.

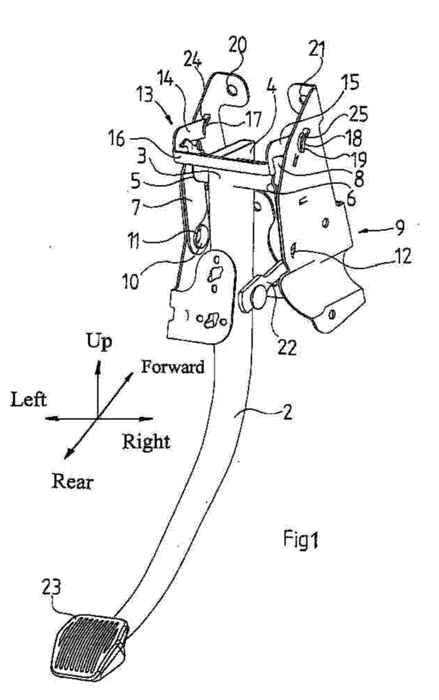

The pedal support which is described in connection with the present invention is positioned on the bulkhead in the passenger compartment at the driver's seat. In FIG. 1, there is shown a pedal support which comprises the major components: a bracket 9, a pedal arm 2 and a pushrod 22. The bracket 9 is secured on the bulkhead with the aid of anchorage devices, for example screws through, int. al. recesses 20 and 21 on the bracket 9. The pushrod 22 runs from the pedal arm 2 and in through an aperture in the bulkhead and is in communication with, for example, a brake servo device that lies in the front area of the vehicle. At the end of the pedal arm 2, a footplate 23 is positioned in order for the driver to be able to give the desired impulses to the pedal arm and the pushrod.

The directions that are described in the present invention are shown in FIG. 1. When, for example, the pedal arm 2 moves forwards, it moves towards the bulkhead and the front area and engine room of the vehicle. When a part moves rearwards, it moves away from the bulkhead, in to the passenger compartment towards the rear area of the vehicle. The terms ‘upwards’, ‘to the left’ and ‘to the right’ entail, in the same manner, that the part moves upwards in the vehicle, towards the left-hand side of the vehicle seen from the driver's perspective when the driver is in the normal driving position, and to the right signifies to the right-hand side of the vehicle.

A locking device 13 which is shown in FIG. 1 is disposed on the bracket 9. The pedal arm 2 may move about a first horizontal shaft 3 and transmit pedal impulses via the pushrod 22 when a pedal device is employed for manoeuvring a vehicle. If the vehicle were to be in a collision, the locking device 13 will be activated so that thereby the upper, horizontal pivot shaft 3 will be free to move in the longitudinal direction of the vehicle, in particular rearwardly. The triggering is active in the sense that it is not dependent on relative movements between vehicle body parts that are deformed during the process of a collision. As a result, the pedal arm will also be free to move in the longitudinal direction of the vehicle by a pivoting movement about the connection of the pushrod 22 with the pedal arm 2. This minimises the movement of the pedal arm 2 rearwardly into the passenger compartment, which is important to minimise the risk of int. al. foot injuries to the driver in connection with a collision.

FIG. 1 shows a pedal support 1 in perspective. The elongate pedal arm 2 is movably disposed about a first horizontal shaft 3 at the upper region 4 of the pedal arm 2. The ends 5 and 6 of the first horizontal shaft are each disposed on a fulcrum 7 and 8 that are each secured in the bracket 9. The fulcrums 7 and 8 are movable about an imaginary second horizontal axis 10 which passes through the points 11 and 12. The fulcrum 7 is, in the point 11, secured in the bracket 9 while the fulcrum 8 is secured in the bracket 9 at point 12.

The first horizontal shaft 3, the fulcrums 7 and 8 and the pedal arm 2 are held in their original effective position by means of the locking device 13. The locking device consists of arms 14 and 15 which are connected to a horizontal plate 16 abutting against the fulcrums 7 and 8. Both of the arms 14 and 15 of the locking device 13 are secured in the bracket 9 at a point 17 and 18, respectively. An imaginary third horizontal axis 19 passes through the points 17 and 18 about which the locking device 13 is movable.

The bracket 9 may be secured on a bulkhead (not shown) with the aid int. al. of the recesses 20 and 21. On the pedal arm 2, the pushrod 22 is pivotally secured and passes through an aperture in the bulkhead in to a brake servo (not shown).

On the outermost lower region of the pedal arm 2, there is disposed the footplate 23. In normal use, the driver depresses the footplate 23, in which event the pedal arm 2 moves about the first horizontal shaft 3, the pushrod 22 moving in through the aperture in the bulkhead and the driver achieving the desired effect using the depression of the footplate 23.

At the anchorage points 17 and 18, locking members 24 and 25 may be provided which prevent the locking device 13 with the arms 14 and 15 and the plate 16 from moving upwards about the third horizontal axis 19. These locking members 24 and 25 are connected to some form of sensor (not shown) which, for example, may be disposed ahead of the bulkhead, i.e. somewhere between the bulkhead and the forward area of the vehicle. This sensor or transducer may sense, for example, a relative movement between, for instance, the engine and the bulkhead. It is also possible to initiate the triggering of the locking device 13 by means of a relative movement between a specific actuator which is placed in the vehicle and a part of the vehicle proper. The relative movement may be transferred to the locking device 13 with the aid of a mechanical device which, for example, may be a fulcrum or a cable. It is also conceivable to remove the locking device 13 in a purely mechanical manner. This may be put into effect in that the engine or the bulkhead is moved during the collision and then comes into contact with some form of pin device which is connected to the locking device 13, in which event the locking device is removed. It is also conceivable to provide a transducer which gives an electric impulse on a collision, the impulse being transmitted to an apparatus that removes the locking device 13. Pyrotechnic removal of the locking device is also conceivable. For example, the transducer and impulse which trigger the collision air bags in a vehicle could also serve as transducer and impulse for removing the locking device 13, for example pyrotechnically. Thus, how the locking device 13 is kept in position and removed from its position may be varied in many different ways and is not restrictive of the scope of the present invention. It is also conceivable to provide a cable which, when taut, lifts up the locking device from its original position. It is also conceivable that the locking device 13 is designed in another manner than that shown in the present embodiment of the invention.

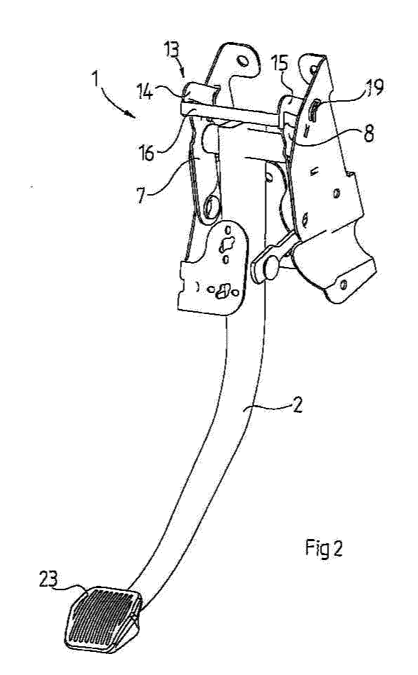

FIG. 2 shows the pedal support 1 in a situation where the sensor in the motor car has emitted impulses that the locking device 13 is to be triggered. FIG. 2 shows how the locking device 13 has moved upwards from its original position in FIG. 1. The locking device 13, which includes the horizontal plate 16 connecting the arm 14 to the arm 15, has, in the Figure, thus moved a slight distance upwards about the third horizontal axis 19. The plate 16 was, in the locking position, disposed against the short side of the fulcrums 7 and 8 but has now released contact with these fulcrums. However, the fulcrums 7 and 8 are still located in their initial position. The pedal arm 2 and the footplate 23 are also in unchanged position in relation to FIG. 1.

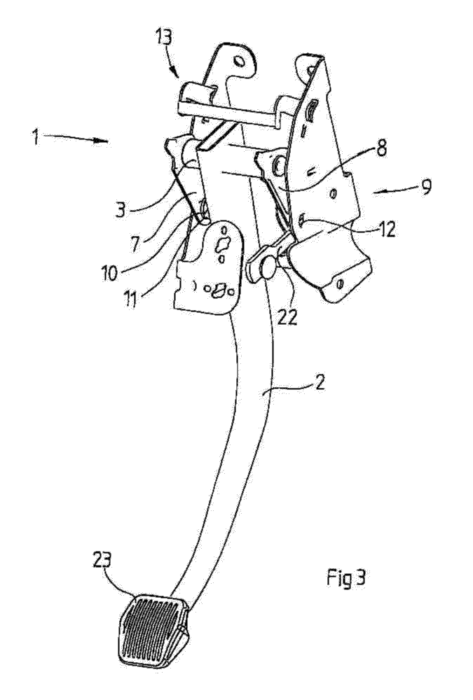

FIG. 3 shows the pedal support 1 in that position where the locking device 13 is wholly released so that the fulcrums 7 and 8 may freely move about the imaginary second horizontal axis 10 through the points 11 and 12.

When the fulcrums 7 and 8 move out from the bracket 9, i.e. rearwardly, the first horizontal shaft 3 also moves rearwardly from the bracket 9. The pedal arm 2 is movably disposed around the first horizontal shaft 3. When the upper region of the pedal arm 2 with the first horizontal shaft 3 moves rearwards from the bracket 9, the lower region of the pedal arm 2 with the footplate 23 may move in the opposite direction, i.e. away from the passenger compartment towards the bulkhead. As a result of this movement towards the bulkhead, there will be obtained a pedal penetration that will be less than if there had been no possibility for the first horizontal shaft 3 to move about the second horizontal axis 10.

The movement of the fulcrums 7 and 8 rearwardly from the bracket 9 and the movement of the first horizontal shaft 3 rearwardly from the bracket 9 are only possible to an extreme position. At this extreme position, the fulcrums 7 and 8 are prevented from moving further rearwards. The shaft 3 is also prevented from continued rearward movement. This arrest at the extreme position may be realised in a number of different ways. For example, an arrest device (not shown) may be provided in the bracket 9, the arrest device stopping the fulcrums 7 and 8 and thereby also the first horizontal shaft 3. The position where this arrest device may be disposed on the bracket 9 may be varied. It is also conceivable to provide an arrest device that acts against the first horizontal shaft 3 and arrests it in its extreme position.

For example, the pedal support 1 may manoeuvre or control the brake of a vehicle. If the driver of this vehicle were to need to use the brake after the locking device 13 has been triggered, this is possible, but possibly with reduced effect. This is possible because the fulcrums 7 and 8 are disposed in the bracket 9 so that the pedal arm 2 may continue to move about the first horizontal shaft 3 in its new position. When the driver depresses the footplate 23, the pedal arm 2 can be moved towards the bulkhead unless the pedal arm comes into contact with the bulkhead, which, after a collision, may be severely deformed (probably no or reduced braking effect). If the brake servo is undamaged and has moved rearwardly and if the pushrod 22 is undamaged, there will in all probability be full braking effect even though the locking device has been triggered. Thus, the present invention offers both lower pedal penetration and, in many cases, continued effect from the pedal after the locking device has been triggered.

### Description of Alternative Embodiments

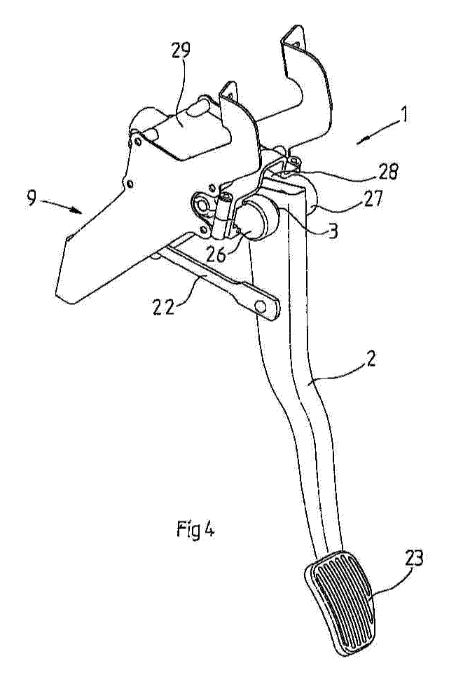

FIG. 4 shows an alternative embodiment of the present invention. In FIG. 4, the pedal assembly 1 is shown disposed in a bracket 9. The pedal assembly 1 includes a pedal arm 2 which, in its upper region, is movable about a first horizontal shaft 3. Lowermost on the pedal arm, there is disposed a footplate 23. An elongate pushrod 22 is pivotally secured to the pedal arm 2. The pushrod 22 passes through an aperture in the bulkhead (not shown) into a brake servo.

In the upper region of the pedal arm 2, each respective end of a carrier arm 26, 27 is disposed on the first horizontal shaft 3, the ends of the carrier arm being interconnected and constituting an elongate slide 28 which is displaceably disposed in a guide 29. The guide 29 is fastened to the bracket 9 and is oriented such that the slide 28 is displaceable in the longitudinal direction of the vehicle, substantially horizontally, FIG. 4 shows the pedal assembly 1 in a normal operational position when the pedal has fun effect, i.e. a force applied on the footplate 23 will achieve the desired result with the aid of the pushrod 22.

In this normal operational position, the slide 28 is protracted forwards in the guide 29 as far as possible. The slide 28 is held in this position by means of a locking device (not shown). Inside the guide 29, there is disposed a device, for example a spring, which urges against a rear portion of the slide 28. The pressure that this spring generates is held back by the locking device when the locking device is in its inactive position.

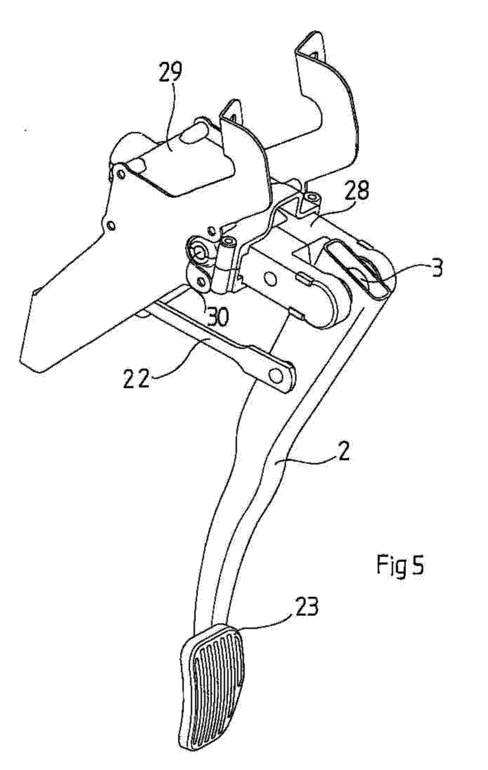

FIG. 5 shows the pedal assembly 1 according to FIG. 4 in the triggered position. In this position, the locking device that held the slide 28 in position has released so that the spring acting on the slide 28 has been capable of pressing out the slide rearwardly a distance out of the guide 29. The slide 28 is prevented from wholly departing from the guide 29 by an arrest member 30 which is disposed on the guide 29. The arrest member 30 may, for example, consist of pins that point inwardly in the guide 29 and cooperate with projecting pins on the slide 28. The pin on the slide is arrested by the pin on the guide and the slide is prevented from continued movement so that the slide 28 is still kept in place, in this position only partially received in the guide 29. In the triggered position as illustrated in FIG. 5, the pedal arm 2 may continue to move about the first horizontal shaft 3 which has now been displaced into the passenger compartment. When the driver depresses the footplate 23, the pressure is transmitted via the pushrod 22. In this position with the slide 28 projecting in its outermost position, the full effect of the pedal will however at least not always be achieved.

The present alternative embodiment of the present invention also enjoys the advantage that it offers a pedal assembly with low pedal penetration in combination with retained residual effect even when the locking device has been triggered.

Further alternative embodiments are possible. The embodiment illustrated may, for example, be modified in that the pushrod 22 is replaced by a drawbar which is positioned above the first horizontal shaft 3 and secured on an extension of the pedal arm 2. When the driver depresses the footplate 23 and the lower region of the pedal arm 2 moves towards the bulkhead, the extended part of the pedal arm that lies above the first horizontal shaft 3 will move away from the bulkhead and entrain the drawbar with it rearwardly into the passenger compartment The drawbar runs through an aperture disposed in the bulkhead. In its other end, the drawbar may be secured, for example, to a brake servo so that the desired effect is obtained via the pedal and the drawbar.

For a vehicle equipped with a pedal assembly according to this embodiment, the first horizontal shaft 3, like the pedal arm 2, is to be displaced forwardly to a safety position in order to give a low pedal penetration in the driver's position and reduce the risk of injuring the driver. Also in this alternative embodiment, a residual function may remain after the first horizontal shaft 3 has been displaced forwards to the safety position. Such an embodiment differs from the embodiment shown in FIG. 4 and in that the slide 28 is in its rearmost position during normal operation and that it is drawn forwardly into the guide in case of a collision.

What is claimed is:

1. A pedal assembly for a vehicle, comprising:
a bracket which is secured in a bulkhead disposed in the vehicle between the passenger compartment of the vehicle and its engine room;
a first shaft which is secured in the bracket and is horizontal and transversely directed in relation to the direction of travel of the vehicle;
a pedal arm provided with a footplate and pivotal about the first shaft;
an operating device which is secured in the pedal arm a distance from the first shaft and which is disposed for activation or control of a vehicular function, the first shaft being movably disposed in the bracket in the direction of travel of the vehicle;
the first shaft having a normal position locked by means of a locking device;
the locking device being, in the event of a collision, openable so as to permit displacement of the first shaft to a safety position where the footplate has been moved away from the legs/feet of the vehicle driver and where the function of the operating device is at least partly retained, wherein the first shaft is provided on a slide which is displaceable in a guide fastened to the bracket.

2. The pedal assembly as claimed in claim 1, wherein the first shaft is displaceable to the safety position when the locking device is in a triggered position; and that an arrest member is disposed along the path of displacement of the shaft with a view to disposing the shaft in the safety position after displacement, in which safety position the pedal arm continues to be movably disposed about the first horizontal shaft and may have an effect, but with reduced function.

3. The pedal assembly as claimed in claim 1, wherein the slide is movable to the safety position.

4. The pedal assembly as claimed in claim 2, wherein the arrest member is disposed in the guide.

5. The pedal assembly as claimed in claim 1, wherein a spring means is disposed against the slide with a view to displacing the slide when the locking device is triggered.

6. The pedal assembly as claimed in claim 1 wherein the locking device is disposed in the guide.

7. The pedal assembly as claimed in claim 1, wherein the locking device is a spring lock.

8. The pedal assembly as claimed in claim 1, wherein the triggering of the locking device is initiated by an impulse from a sensor disposed in the vehicle.

9. The pedal assembly as claimed in claim 1, wherein the triggering of the locking device is initiated by a relative movement between an actuator and a part in the vehicle.

10. The pedal assembly as claimed in claim 9, wherein the relative movement is transferred to the locking device by means of a mechanical arrangement.
